(19) United States
(12) Patent Application Publication
(10) Pub. No.: US 2002/0076005 A1
(43) Pub. Date: Jun. 20, 2002

(54) Automated messaging for called number locations capable of limited interactions

(76) Inventor: Thomas Michael Bauer, Hillsborough, NJ (US)

Correspondence Address: Henry T. Brendzel, P.O. Box 574, Springfield, NJ, 07081, US

(21) Appl. No.: 09/736,857

(22) Filed: Dec. 14, 2000

(51) Int. Cl. H04M 1/64; H04M 11/00

(52) U.S. Cl. 379/67.1; 379/88.16

(57) ABSTRACT

In situations where the calling party is connected to Limited-Intelligence Incoming Call-Accepting (LIICA) terminating entity, for example, a telephone answering machine, a much more satisfactory interaction is had for both the calling party and the called party when the telephone service provider's system detects that a connection is being made to LIICA entity and provides the calling party with the option to leave a message in the provider's messaging platform. When the caller accepts that option, the system interacts with the caller in a conventional way to leave a message on the messaging platform, and also interacts with the LIICA entity (if possible) to leave a short message thereon that informs the called party that a message is waiting for the called party on the messaging platform, which can be retrieved at the called party's discretion.

### BACKGROUND OF THE INVENTION

This invention relates to calls made to call-terminating points that are capable of only limited interactions with the caller.

Interesting challenges arise in situations where a call's terminating point is less able to interact with callers than is normally expected. For example, such a situation arises when a collect call is attempted to a party at a given called number, but the terminating point of that called number has a telephone answering machine. As is well known, collect calls allow a caller to transfer charges for a call from the calling party's account to the called party's account, at the option of the called party, but to do that, the called party must accept the charges. An answering machine, however, has a very limited capability for interacting with the calling party (or with the collect-call operator, or automated system); hence, the challenge.

Some years ago, collect calls required operator assistance, but this need has be removed with arrangements not unlike the one described in U.S. Pat. No. 4,797,910, which describes a speech recognition unit that is a part of an operator assistance switch. The unit participates in the automatic establishment of the call by contacting the called party, with a synthesized voice asking the caller to accept charges, and when the speech recognition unit determines that the called customer accepts the charges, the caller is connected to the called party, and the called party is charged for the call.

In a slightly different aspect of telecommunications, U.S. Pat. No. 4,932,042 describes an arrangement for converting a call to a number that is busy or does not answer to a voice message call, without requiring the caller to re-originate the call. This is accomplished with a toll switch that includes a dual tone multi-frequency (DTMF) receiver and a Voice Message Operations Center (VMOC) having voice messaging equipment. When the toll switch receives a call, it attaches a DTMF receiver to the call, pending reception of an answer, in order to detect signals keyed by the calling customer. A message informing the calling customer of the availability of voice messaging service may be played during the ringing period or during the busy signal. While the calling customer is not yet connected (i.e., during ringing, or during a busy signal), the customer can dial a pre-selected key sequence which, when detected by the DTMF receiver of the toll switch, causes the switch to connect the calling customer to the VMOC; i.e., the messaging platform. The VMOC records the customer's message and later attempts to deliver it to the called party. The caller pays for the service of storing the message for the called party. The delivery attempt can be pro-active, with the VMOC dialing the called party, with some selected frequency, until a connection is made and the message is delivered. Alternatively, the delivery attempt is more passive, for example with the VMOC informing the called party's central office that a message is waiting, and the central office conditioning its dial-tone circuit to provide a stutter dial tone to the called party when the called party goes “off-hook.” The teachings of the 4,932,042 patent are extended from unacknowledged conventional calls (i.e., “busy” and “no answer” calls) to unacknowledged collect calls by U.S. Pat. No. 5,463,677, offering the caller the opportunity to store a message, e.g., a voice message, in a messaging platform at no charge to the caller. After the caller stores a message, one or more attempts are made to establish a connection between the messaging platform and the called party's telephone. This may be done by periodically alerting the called party's telephone (in the case of a “busy,” when it is back “on-hook.”) When the called party answers, the messaging platform informs the called party that a collect voice message awaits the called party and asks whether the called party is willing to pay to receive the message. If the called party signals the acceptance of charges, the messaging platform plays the stored voice message from the collect caller, and signals the telephone network to charge the account of the called party for the message. If the called party does not accept charges, the message is not delivered.

Between the teachings of U.S. Pat. No. 4,797,910, which handles collect calls that reach a person at the called party's location, and the teachings of U.S. Pat. No. 5,463,677, which handles collect calls that are unacknowledged, almost all circumstances that involve collect calls are covered. One circumstance that is not covered is when a collect call is answered by a person who is less than fully capable of intelligent voice interaction (e.g., a small child), or by equipment that is less than fully capable of intelligent voice interaction (e.g., an answering machine). In this situation a call is established to the called party, and resources of the service provider's have been expended but, since the answering machine does not have the intelligence to decide whether to accept charges for the collect call, the service provider gets no payment. U.S. Pat. No. 4,734,929, provides a partial solution by suggesting that the user who connects an answering machine to the telephone line can include the phrase “collect call OK” (or a similar phrase) in the greeting. The automated system described in U.S. Pat. No. 4,797,910 includes a speech recognition unit that recognizes the “collect call OK” phrase within the greeting message and connects the caller to the answering machine.

There are a number of problems with this solution, however. Primarily, the caller is connected to an answering machine, and while completing a call is generally assumed to be the desired result, in the case of collect calls it is likely to be unsatisfactory to the person placing the “collect” call since, typically, collect calls are made by persons who urgently want to communicate with the called party. Another problem relates to the lack of effective control on the part of the answering machine's owner over which persons would leave a message and incur charges for the answering machine's owner. Still another problem relates to the “intelligence” of the speech recognition unit. If the speech synthesis unit of the automated system expects the answer “yes” or “no” in response to its query “will you accept charges?” a lengthy response by an answering machine, which includes a synthesized phrase “Collect Call OK” might not be handled as anticipated.

The above demonstrates that being connected to an answering machine is problematic for collect calls or similarly for any message delivery service/function which is expected to obtain an acknowledgement of acceptance of charges, of readiness to receive, or of appropriateness of recipient. In fact, being connected to an answering machine is undesirable in other situations as well. This includes, for example, when the caller (be it a person or an automatically dialing system) wishes to interact with the called party, but does not wish to interact with an answering machine.

In an attempt to overcome this problem, U.S. Pat. No. 5,581,602 describes an arrangement for non-offensive termination of a call made by an automated dialing system that reaches an answering machine. When the method detects that a call reached an answering machine, a termination message is played, such as “Excuse me, I must have dialed the wrong number.” Aside from the fact that this solution is wholly unsatisfactory for collect calls, it is also unsatisfactory for conventional, caller-pays, calls. Moreover, an arrangement that effectively institutionalizes subverting the truth, such as by saying that a wrong number was reached when in fact it was not, is not a laudable solution.

### SUMMARY

In situations where the calling party is connected to Limited-Intelligence Incoming Call-Accepting (LIICA) terminating entity —such as a telephone answering machine, or a person who has limited capacity—a much more satisfactory interaction is had for both the calling party and the called party when the telephone service provider's system detects that a connection is being made to LIICA entity and provides the calling party with the option to leave a message in the provider's messaging platform. When the caller accepts that option, the system interacts with the caller in a conventional way to leave a message on the messaging platform, and also interacts with the LIICA entity (if possible) to leave a short message thereon that informs the called party that a message is waiting for the called party on the messaging platform, which can be retrieved at the called party's discretion.

### BRIEF DESCRIPTION OF THE DRAWING

FIG. 1 shows one illustrative arrangement in conformance with the principles disclosed herein;

FIG. 2 shows a flowchart of an exemplary process for the making of collect calls to terminals that turn out to be telephone answering machines; and

FIG. 3 shows a flowchart of an exemplary process for retrieving/delivering a collect message stored in the FIG. 1 arrangement.

### DETAILED DESCRIPTION

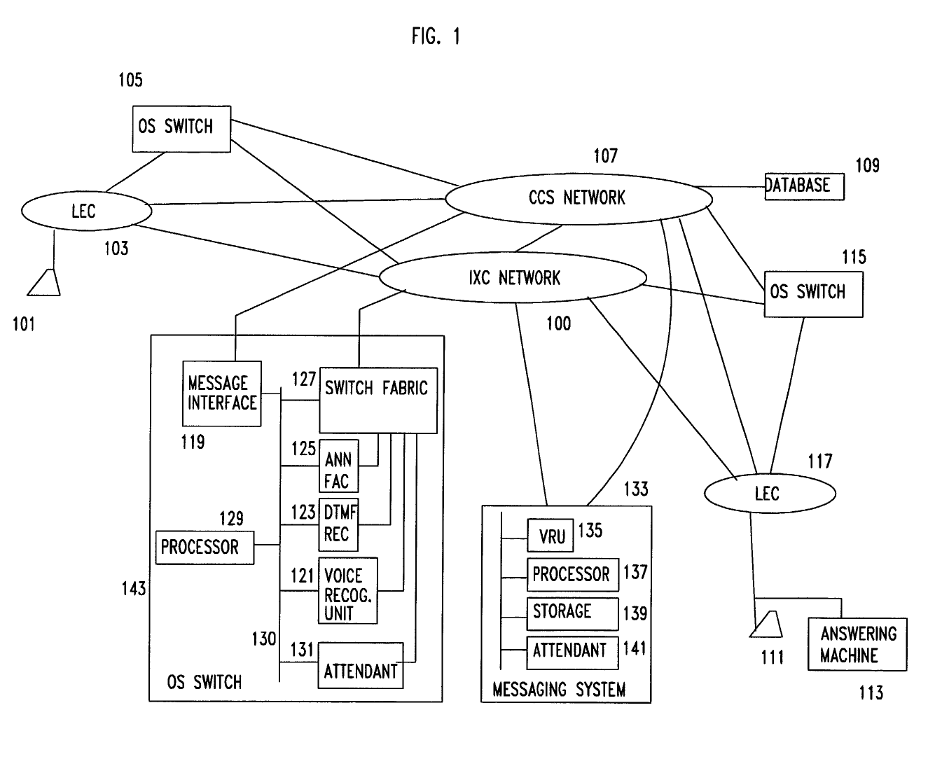

FIG. 1 presents an illustrative arrangement wherein the principles of this invention may be practiced. It depicts a telephone station 101 that is connected to local exchange carrier (LEC) 103, and LEC 103 is connected to inter-exchange carrier (IXC) network 100, and to the common control signaling (CCS) network 107. Illustratively, the telecommunication services provider that owns LEC network 103, e.g., Verizon, also owns Operator Services switch 105 and, therefore, LEC network 103 is also connected OS switch 105. FIG. 1 also depicts a telephone terminal 111 to which an answering machine 113 is connected. Terminal 111 is connected to LEC 117, and LEC 117 is connected to IXC network 100, and to CCS network 107. Illustratively, a different telecommunication services provider owns LEC network 117, e.g., US West, and it interacts with Operator Services switch 115. CCS network 107 contains information about IXC network 100 and other information that is relevant to its signaling function, and that information is stored in database 109. OS switch 143, which is connected to IXC network 100 and to CCS network 107 may belong to the telecommunication provider to which IXC network 100 belongs, e.g., AT&T.

The OS switches include, or are connected to, one or more attendant stations. For sake of simplicity, only attendant station 131 is depicted; it being connected to control bus 130 within OS switch 143, and to switch fabric 127 within OS switch 143. Switch fabric 143 is also connected to bus 130, as are processor 129, announcement facility 125, DTMF receiver 123, voice recognition unit 121, and message interface unit 119. Message interface unit 119 is the element within OS switch 143 that connects to the CCS network 107, and switch fabric 127 is the element within OS switch 143 that connects to the IXC network 100. Within OS switch 143, announcement facility 125, DTMF receiver 123, and voice recognition unit 121 are also connected to switch fabric 127. They are all of conventional design.

OS switches 105 and 115 may be identical to OS switch 143, except that the switch fabrics of OS switches 105 and 115 also have a connection to the associated LEC networks, as mentioned above.

Lastly, messaging platform 133 is connected to IXC network 100 and to CCS network 107. Within platform 133, there is a voice response unit 135 that is controlled by processor 137, a storage unit 139, and an attendant position 141. Messaging platform 133 may also contain a voice recognition unit either as a separate element or as a subcomponent of the voice response unit 135. It is noted that the term “messaging platform,” as used herein and as commonly used in the art, does not include telephone answering machines. Stated conversely, in the context of this disclosure, an answering machine, such as answering machine 113, is not a messaging platform.

The OS switches are adapted to offer numerous services. One such service is processing collect calls—for example, from telephone station 101 to a party at telephone 111. Processor 129 controls the overall operation of OS switch 143 via bus 130 by performing the necessary processing and exchanging of messages with the other components of OS switch 143. Announcement facility 125 can present different announcements that can be heard by callers or called parties. The announcements, or combinative portions thereof, are pre-stored in announcement facility 125 and accessed by supplying announcement facility 125 with pointers to the announcements. Dual tone multi-frequency receiver 123 receives dual tone multi-frequency signals that are transmitted in response to the pressing of keys on the keypad of telephone stations (such as station 101) and supplies the digit corresponding to each pressed key to processor 129.

Message interface unit 119 is a protocol conversion unit that permits operator services switch 143 to communicate with the CCS network 107. It is responsible for formatting all messages transmitted to CCS network 107 and for extracting responses received from CCS network 107.

Switch fabric 127 within switch 143 is adapted to connect trunks on which a caller's call arrives at operator services switch 143 from LEC network 103 to announcement facility 125, dual tone multi-frequency receiver 123, voice recognition unit 121, attendant position 131, or to IXC network 100. The purposes of such connections are described below.

Attendant position 131, serviced by a human attendant, interfaces with operator services switch 143 via both bus 130 and switch fabric 127. The bus 130 interface permits the attendant to exchange information with processor 129. The switch fabric 127 interface allows the attendant to interact (e.g., converse) with the caller in order to assist the caller in the placing of a collect call, or interact with the entity that answers the call to terminal 111 (e.g., converse with a party that takes telephone terminal 111 “off-hook,” or interact with or answering machine 113) in the course of establishing the collect call, or initiating the process for the storing of a collect message.

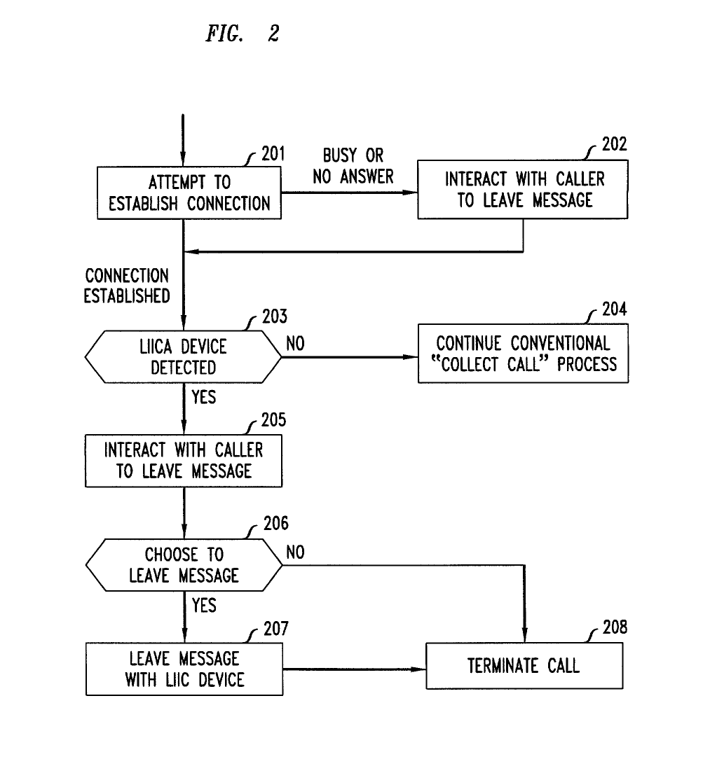

FIG. 2 shows a flowchart of a process in accord with the principles disclosed herein. The process is entered in step 201 when a caller originates a call in connection with which the caller wishes to have other than the conventional type of interaction with the called party. Specifically, FIG. 2 discloses a process for handling calls when other than conventional treatment is to be given the call, should the call be completed to a LIICA entity. One example of a LIICA entity is a telephone-answering device. Another example of a LIICA entity is a pager. A third example of a LIICA entity is a modem that is connected to a fax machine or to a computer.

For purposes of illustration, FIG. 2 is a flowchart for a process that is carried out in an OS switch, such as within OS switch 105 or OS switch 143, when the caller at terminal 101 wishes to place a collect call, by dialing 0+area code+number, or by dialing an IXC access code+0+area code+number, or by dialing an IXC's 8YY-NXX-XXXX service access number. A switch within LEC 103 receives the digits dialed by terminal 101, recognizes whether the call is a LEC-handled call or an IXC-handled call, recognizes that the call is an operator-services type call and, accordingly, routes the call to either OS switch 105 or OS switch 143. For purposes of exposition, it is assumed that the caller tries to place the collect call to terminal 111, and that, accordingly, the call is directed to OS switch 143.

In step 201, operator services switch 143 attempts to establish a connection to the called party. The connection to the called party will either be established, or not, and control passes to block 203 or 202, respectively.

When a connection cannot be established, because of a busy condition or a no-answer condition, control passes to step 202 where a conventional treatment is given to the call. In an arrangement that practices the principles of this invention, this conventional treatment most likely comprises routing of the call to a messaging platform when a LIICA entity is detected, for example in accordance with the teachings of U.S. Pat. No. 4,932,042. The call is directed to messaging platform 133, with attendant information that the process to be initiated is one of accepting a collect call message to be stored in the platform, and the initiated process drives voice response unit (VRU) 135 to interact with the caller, inviting the caller to leave a message. This process is conventional. Information about the caller and the called party is passed from operator system 143 to messaging platform 133 via the CCS network 107, and that information is associated with the message that is stored in platform 133. That is, messaging platform 133 contains the message, the caller who left the message, the party for whom the message is stored, and perhaps some other identifier, such as a password. At least in some arrangements, a message is also sent to LEC 117, for example, by CCS network 107, to enable the LEC to alert terminal 111 about the message that is stored in messaging platform 133; for example, by providing a stutter dial tone to terminal 111 (when terminal 111 goes “off-hook”). When the called party calls messaging platform 133 to retrieve the massage, platform 133 could use the ANI of telephone device 111, or request the called party to enter the number of the telephone device 111 which the message was left at to check for stored messages. When at least one message is found, then the messages related stored information is provided as to who left the message, and a request is made to accept collect call charges for the message. If the charges are accepted, the message is delivered. Otherwise, the message is not delivered (and discarded). In other arrangements, messaging platform 133 attempts to deliver the stored message by waiting a pre-selected period of time and then dials the called party. When the called party answers, step 202 passes control to step 203.

When a connection to the called party is established and control passes to step 203, a determination is made whether a LIICA entity was reached. Each different LIICA entity has its own unique characteristics that can be used to determine the presence of an LIICA entity. In the case of a telephone-answering device, it is characterized by a relatively lengthy greeting message terminated by a “beep” sound. For example, in contrast to a simple greeting given by a person, such as “hello,” “Jones speaking,” or “Household Finance,” answering machines usually identity the party that was reached, reveal the fact that an answering machine was reached, and provide instructions as to what to do. The combination of voice recognizer unit 121 and processor 129 ascertains in step 203 first whether an LIICA entity was reached, or a person who is capable of the expected level of interaction (hereinafter, a “communicative person”). If it is concluded that an LIICA entity was reached, step 203 then proceeds to identify the type of device that was reached.

The specific methods that may be employed to identify the type of LIICA entity that was reached do not form a part of this invention, but it is clear that the tests employed can be quite simple. To just give an illustration, a modem emits a very specific tone and, therefore, if the LIICA entity is a modem (for example, of a fax machine) voice recognition unit 121 can easily identify this tone and reach the appropriate conclusion.

When step 203 determines that a communicative person was reached, control of the FIG. 2 process passes to step 204, where the conventional “collect call” process is continued. That is, information about the caller is provided to the called party while the voice path from the caller to the called party is muted, and the called party is requested to accept charges. When the called party accepts charges, the voice connection from the caller to the called party is enabled, and the conversation between the parties proceeds. In situations where step 204 is arrived at via step 202, the connection, of course, is from messaging platform 133 rather than from the caller.

When step 203 determines that an LIICA entity was reached at the called party's number—e.g., telephone answering device 113—rather than a communicative person, control passes to step 205 which interacts with the caller to leave a message for the called party. The process carried out in step 205 can be essentially identical to the process carried out in step 202. Of course, the initial prompt to the caller will not be something like “your party is busy” but rather, something like “the party you wish to reach is unavailable.” Of course, if the OS switch is intelligent enough to actually ascertain that an answering machine was reached, the prompt to the caller might be: “it appears you have reached an answering machine.”

Whether the caller chooses to leave a message or not is decided in step 206. If the caller chooses to not leave a message, control passes to step 208, where the process terminates. If the caller chooses to leave a message, control passes to step 207, where a system-generated message is left with the LIICA entity, if possible. In the case of telephone answering device 113, one possible example is for OS switch 143 to construct a message such as “Your messaging platform is holding a collect call message for Bob Jones from a Rita Jones, who placed a call from area code 203, number 345-1234.” Another method for providing a ‘retrieval notification’ message on the LIICA entity would be to leave no message from OS switch 143 but, rather, conditions messaging platform 133 to place a subsequent call to the called party telephone device 111. Upon connection, the messaging platform performs the LIICA detection function. When it detects answering machine 113, the platform leaves the retrieval notification message. When it reaches a communicative person, the platform proceeds with the message acceptance process of step 204.

It may be noted that the above makes a distinction between communicative persons, and other persons. This recognizes that some persons who might answer telephone 111 might not be capable of the expected level of communication. How to determine a communicative person from a non-communicative person is, of course, a designer's choice. The basic approach is to attempt to communicate and, at some point, to decide that communication is not fruitful. For example, OS switch 143 might ask the question “will you accept charges?” An answer such as “I am six” may be a good hint that a small child was reached. The sophistication of the process used to differentiate between communicative persons and non-communicative persons is a design choice, and does not form a part of this invention.

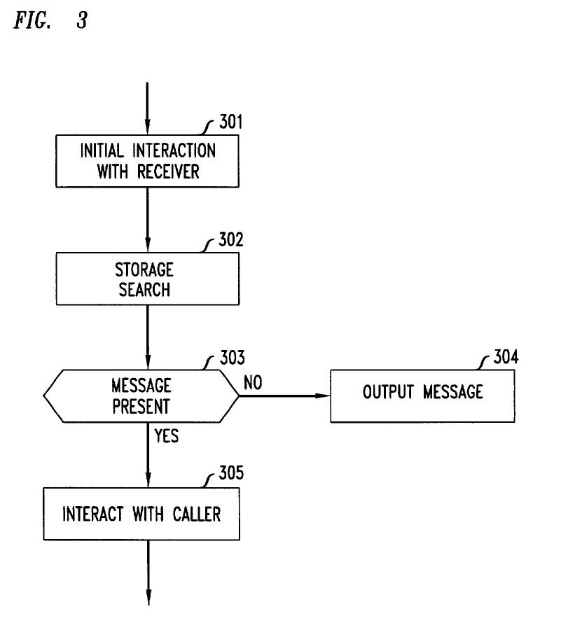

For purposes of illustration, FIG. 3 is a flowchart for a process that is carried out in the messaging platform 133, when the caller at terminal 111 (or another like terminal) wishes to retrieve the message that has been stored there from the call process described above in FIG. 2. A switch within LEC 117 receives the digits dialed by terminal 111, recognizes that the call is to be directed to the IXC's network 100. The IXC network 100 receives the call's signaling information from LEC 117 via the CCS network 107 and the call is then directed to the messaging platform 133, most likely via 8YY call processing.

When messaging platform 133 receives the call processor 137 ascertains whether it relates to the storing of a collect call message, or to the retrieval of a message. If it's the latter, the FIG. 3 process is launched. Step 301 provides the initial interaction with the user, for example asking whether the inquiry relates to calls made to the telephone number from which the caller is placing the call, or to a different called number. If the inquiry relates to the telephone number from which the caller is placing the call, then the ANI information is forwarded to step 302. Otherwise, the called number provided by the caller is forwarded to step 302. Other information, such as the number dialed by the caller, e.g., 1-800GET-AMSG, and/or any other information that was entered by the caller at step 301 are forwarded to step 302. In step 302 a search is made of storage 130 to determine whether messages are stored that correspond to the information that was provided to step 302. There may be no messages, some messages, and/or some messages that call for delivery only upon submission of a bona fide password. Step 303 makes that determination and, if there are no messages, passes control to step 304, where an appropriate message is delivered to the party making the inquiry and the process terminates. When one or more messages are found, control passes to step 305 where, in connection with each message and/or a group of messages, an interactive session is held with the caller, handling the message or messages as desired by the caller. As part of this interaction, the identity of the person who seeks to retrieve the messages is ascertained, at least in some embodiments and, in those embodiments, at least in connection with some of the messages. The identity of the person who seeks to retrieve messages can be through a password, through voice recognition of a response in response to an inquiry from the platform (e.g., ascertain the response to a question such as “state your name, please”), etc.

To illustrate, the interaction might be as follows:

“Please enter the phone number for which messages may be stored. If it's the phone number that you are using now, please press the pound key.”

User presses the # key

“You have one collect call message and three other messages. For the collect call, please enter the password of assigned to that call”

user presses: <special password>

“Thank-you. You have a collect call from Rita Jones. If you will accept charges, say YES. Otherwise, say NO.”

user says “YES”

“Thank-you. The collect call message is: <the recorded message is outputted>”“If you wish to repeat the message, press 1. If you wish to keep the message, press 2. If you wish to delete the message, press 3”

user responds

“You also have three other messages. Please enter your normal password.”

User enters <normal password>

“Your first message is <output first message>”

“If you wish to repeat the message, press 1. If you wish to keep the message, press 2. If you wish to delete the message, press 3”

user responds

etc.

As can be seen from the above, the inclusion of attendant position 141 is not absolutely required. In systems that do have attendant position 141 callers can be connected to an attendant who is able to perform the equivalent functions that the VRU 135 and processor 137 perform in automated interactions with the caller.

The foregoing merely illustrates the principles of the invention, and it should be appreciated that the principles of this invention can be employed in connection with services other than collect calls, and that persons skilled in the art will be able to devise various arrangements which, although not explicitly described or shown herein, embody the principles of the invention and are thus within its spirit and scope. In connection with services, for example, the principles of this invention would apply for all situations where the LIICA entity cannot store messages, including a telephone answering machine that exhausted it capacity to store messages. In connection with structure, for example, the arrangement depicted in FIG. 1 utilizes an Operator Services switch (such as OS switch 143), but for other service applications the architecture may only rely on a service platform that could be network based, adjunct based, or implemented via an Advanced Intelligent Network system.

1. A method for handling telecommunications calls comprising the steps of:
in response to a request from a calling party, establishing a connection to a called number;
determining whether said connection is established to a LIICA entity;
when said step of determining concludes that said connection is established to a LIICA entity, presenting said calling party an offer to store a message on a messaging platform.

2. The method of claim 1 wherein said step of offering comprises:
providing a prompt to said calling party that solicits a response from said calling party regarding whether said calling party wishes to store a message,
coupling said calling party to said messaging platform when said response is affirmative, and
storing a message from said calling party in said messaging platform.

3. The method of claim 1 wherein said step of offering comprises:
coupling said calling party to said messaging platform,
providing a prompt to said calling party that solicits a response from said calling party regarding whether said calling party wishes to store a message, and
when said response is affirmative, storing a message from said calling party in said messaging platform.

4. The method of claim 1 where said LIICA entity is any entity other than a communicative person.

5. The method of claim 1 where said LIICA entity is taken from a set that includes a telephone answering machine, a fax machine, and a modem.

6. The method of claim 1 further comprising a step of storing a message on said messaging platform in response to acceptance by said calling party of said offer.

7. The method of claim 6 further comprising a step of providing a message to said LIICA entity.

8. The method of claim 7 where said provided message is stored in said LIICA entity.

9. The method of claim 7 where said message provided to said LIICA entity identifies the calling party.

10. The method of claim 7 where said message provided to said LIICA entity identifies a nature of a message stored from said calling party in said messaging platform.

11. The method of claim 10 where said nature of from said calling party in said messaging platform is that of a call that requires a party that retrieves a message stored in said messaging platform to agree to pay a fee.

12. The method of claim 1 further comprising the steps of:
preceding the step of establishing a connection to a called number, receiving a request for a connection from said calling party.

13. The method of claim 12 further comprising the steps of:
preceding the step of establishing a connection to a called number, receiving a request for a connection from said calling party; and
interacting with said calling party to establish that said calling party wishes to receive a call treatment that might lead to an offer, made to said calling party, to store a message in said messaging platform.

14. The method of claim 1 further comprising the steps of:
preceding the step of establishing a special-services connection to a called number, receiving a request for a connection from said calling party.

15. The method of claim 14 further comprising the steps of:
interacting with said calling party to enable the establishment of said special-services connection.

16. The method of claim 15 where said special-services connection is a collect-call connection, and said step of interacting includes said calling party identifying itself.

17. The method of claim 15 where said step of interacting includes providing an offer to said calling party to store a message in said messaging platform.

18. The method of claim 17 where said step of interacting further includes storing a message from said calling party in said messaging platform.

19. The method of claim 1 further comprising the steps of:
receiving a request from an inquiring party to retrieve stored messages,
ascertaining identity of said inquiring party,
when said step of ascertaining identifies that messages are present in said message platform for said inquiring party, retrieving a stored message from said messaging platform.

20. The method of claim 1 further comprising the steps of:
receiving a request from an inquiring party to retrieve stored messages,
ascertaining identity of said inquiring party,
ascertaining willingness of said inquiring party to pay for retrieval of a stored message, and
when said step of ascertaining willingness concludes that said inquiring party agreed to pay for delivery of a message, retrieving a stored message from said messaging platform.

21. A method for handling inquiries to a messaging platform comprising the steps of:
receiving a request from an inquiring party to retrieve stored messages,
ascertaining identity of said inquiring party,
ascertaining willingness of said inquiring party to pay a per-message payment for retrieval of a stored message, and
when said step of ascertaining willingness concludes that said inquiring party agreed to pay said per-message payment for delivery of a message, retrieving a stored message from said messaging platform.
